(19) United States
(12) Patent Application Publication
(10) Pub. No.: US 2010/0245204 A1
(43) Pub. Date: Sep. 30, 2010

(54) CIRCULARLY POLARIZED ANTENNA FOR SATELLITE COMMUNICATION

(75) Inventors: Jae Wook LEE, Gyeonggi-do (KR); Dong Yeon KIM, Gyeonggi-do (KR); Tae Yoon SEO, Gyeonggi-do (KR); Sung Hwan AHN, Seoul (KR)

Correspondence Address: CANTOR COLBURN, LLP, 20 Church Street, 22nd Floor, Hartford, CT, 06103, US

(73) Assignee: UNIVERSITY INDUSTRY COOPERATION FOUNDATION KOREA AEROSPACE UNIVERSITY, Goyang-si (KR)

(21) Appl. No.: 12/751,392

(22) Filed: Mar. 31, 2010

(30) Foreign Application Priority Data
Mar. 31, 2009 (KR) 10-2009-0027593

(51) Int. Cl. H01Q 9/04; H01Q 1/50

(52) U.S. Cl. 343/860; 343/700 MS

(57) ABSTRACT

A circularly polarized antenna includes a dielectric substrate having a first via array in the form of a cylindrical cavity, a micro-strip circular patch antenna located at the center of the cylindrical cavity and formed on the dielectric substrate to radiate a signal, and a rectangular dielectrically loaded waveguide having a second via array and serving to feed the signal to the micro-strip circular patch antenna. Accordingly, the circularly polarized antenna prevents impedance mismatch between the micro-strip antenna and the dielectrically loaded waveguide and broadens an impedance bandwidth thereof.

### BACKGROUND OF THE INVENTION

1. Field of the Invention

The present invention relates to a circularly polarized antenna for satellite communication, and more particularly, to a circularly polarized antenna for satellite communication, which adopts a feed method using a dielectrically loaded waveguide and realizes a small antenna using a waveguide capable of being integrated on a single dielectric substrate, thereby minimizing feed loss in a high frequency band of satellite communication and broadening an impedance bandwidth via integration of an impedance matching network and circular polarization.

2. Description of the Related Art

Antennas devised to be mounted and used in satellites have needs for stabilized gain, circular polarization and bandwidths. In addition, these antennas must have strong heat resistance to exhibit stabilized characteristics even under space environments and must be designed firmly and lightly to prevent physical damage thereto even by vibration and external shock.

In the case of a feed network of an antenna for use in a frequency range of an X-band (8˜12 GHz) or more, minimizing line loss is a key point.

A micro-strip or strip line usable with a dielectric substrate has been used in a feed network of a micro-strip single patch antenna and an array antenna. In the case of a satellite mounted antenna having a strict need for low line loss, the micro-strip or strip line may be substituted by a metal waveguide, to maximize energy transmission efficiency. However, the metal waveguide has disadvantages of a heavy weight and large volume.

Recent technologies enable realization of a rectangular Substrate Integrated Waveguide (SIW), which adopts a via array metal wall and can be integrated on a dielectric substrate. When using such a waveguide integrated on a dielectric substrate, it is possible to realize a light-weight waveguide having low line loss.

In the meantime, to minimize return loss of an antenna, it is essential to provide the antenna with an impedance matching network, to prevent impedance mismatch between a cylindrical cavity type micro-strip patch antenna and a dielectrically loaded waveguide feeder.

Technologies related to realization of a rectangular or cylindrical cavity type via array radiator are disclosed in an article entitled “PLANAR SLOT ANTENNA BACKED BY SUBSTRATE INTEGRATED WAVEGUIDE CAVITY” by Guo Qing Luo (IEEE Antennas and Wireless Propagation Letters, vol. 7, 2008), and an article entitled “SINGLE PROBE FED CAVITY BACKED CIRCULARLY POLARIZED ANTENNA” by Guo Qing Luo (Microwave and Optical Technology Letters, vol. 50, No. 11, November, 2008).

Disclosed in the former article, entitled “PLANAR SLOT ANTENNA BACKED BY SUBSTRATE INTEGRATED WAVEGUIDE CAVITY” by Guo Qing Luo (IEEE Antennas and Wireless Propagation Letters, vol. 7, 2008), is an antenna using a straight slot to generate a linearly polarized wave, which has difficulty preventing radiation loss of a micro-strip feed line. Another disadvantage of the disclosed antenna is a narrow impedance bandwidth due to the absence of an impedance matching network.

The latter article, entitled “SINGLE PROBE FED CAVITY BACKED CIRCULARLY POLARIZED ANTENNA” by Guo Qing Luo (Microwave and Optical Technology Letters, vol. 50, No. 11, November, 2008), proposes an antenna using a cross-shaped slot to generate a circularly polarized wave, which adopts a probe feed method using a Sub-Miniature version A (SMA) connector. In this case, it is impossible to realize a multi-feed array antenna because all spaces are sheltered by a via array defining a cylindrical cavity. In addition, similar to the former article, the disclosed antenna may suffer from impedance bandwidth narrowing by 3.2% on the basis of a −10 dB impedance bandwidth due to the absence of an impedance matching network, and therefore, has difficulty in use for X-band satellite communication that requires a bandwidth of 400 MHz or more.

### SUMMARY OF THE INVENTION

Therefore, the present invention has been made in view of the above problems of conventional communication antennas, and it is an object of the present invention to provide a circularly polarized antenna for satellite communication, which adopts a feed method using a dielectrically loaded waveguide and realizes a small antenna using a waveguide capable of being integrated on a single dielectric substrate.

It is another object of the present invention to provide a circularly polarized antenna for satellite communication, which can minimize feed loss in a high frequency band of satellite communication and can broaden an impedance bandwidth via integration of an impedance matching network and circular polarization.

It is a further object of the present invention to provide a circularly polarized antenna for satellite communication, which can achieve higher gain and transmission efficiency than a conventional micro-strip circularly polarized antenna, and can exhibit a minimized volume and weight thereof using a cylindrical cavity type via array on a single dielectric substrate.

In accordance with the present invention, the above and other objects can be accomplished by the provision of a circularly polarized antenna for satellite communication including a dielectric substrate having a first via array in the form of a cylindrical cavity, a micro-strip circular patch antenna located at the center of the cylindrical cavity and formed on the dielectric substrate to radiate a signal, and a rectangular dielectrically loaded waveguide having a second via array and serving to feed the signal to the micro-strip circular patch antenna.

The rectangular dielectrically loaded waveguide may be formed in the dielectric substrate.

The circularly polarized antenna for satellite communication may further include an etching pattern and a third via array constituting an impedance matching network to realize impedance matching between the rectangular dielectrically loaded waveguide and the micro-strip circular patch antenna.

The circularly polarized antenna for satellite communication may further include a micro-strip line formed on an upper plate located over the dielectric substrate and serving to receive the signal.

The second via array may be parallel to the micro-strip line and may be formed at left and right sides of the micro-strip line.

The third via array may be perpendicular to the second via array and may be formed at a left or right side of the micro-strip line.

The third via array may serve not only as the impedance matching network, but also as a transformer for mode transformation from TE10 mode as a fundamental mode of a feeder defined by the rectangular dielectrically loaded waveguide to TM11 mode as a fundamental mode of the micro-strip circular patch antenna.

The upper plate may include a signal transition connected to one end of the micro-strip line for transmission of the signal between the micro-strip line and the dielectrically loaded waveguide.

The micro-strip circular patch antenna may have a slot to create two electric fields, which have the same magnitude and a phase difference of 90 degrees, and the micro-strip circular patch antenna may adjust a purity and center frequency of an axial ratio according to an area of the slot and a ratio of a horizontal length value to a vertical length value of the area.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a 3D exploded perspective view illustrating a substrate integrated cylindrical cavity type circularly polarized antenna and an impedance matching network;

FIG. 1B is a 3D exploded perspective view illustrating a coupling relationship between a micro-strip line and a transition used to connect the micro-strip line and a dielectrically loaded waveguide to each other, to measure characteristics of the antenna of FIG. 1A;

FIG. 1C is a plan view and a side view of FIG. 1B;

FIG. 2 is a detailed plan view illustrating an impedance matching network consisting of an etching pattern and a via array inside the dielectrically loaded waveguide of FIG. 1B;

FIG. 3 is a comparative graph illustrating return loss depending on the presence or absence of an impedance matching via array;

FIG. 4A is a comparative graph illustrating simulation results of impedance matching variation depending on variation of a horizontal value of an etching pattern constituting an impedance matching network;

FIG. 4B is a comparative graph illustrating simulation results of impedance matching variation depending on variation of a vertical value of an etching pattern constituting an impedance matching network;

FIG. 4C is a comparative graph illustrating simulation results of impedance matching variation depending on variation of an entire length value of an etching pattern constituting an impedance matching network;

FIG. 5A is a comparative graph illustrating simulation results of impedance matching variation depending on variation of a via count of a via array constituting an impedance matching network;

FIG. 5B is a comparative graph illustrating simulation results of impedance matching variation depending on variation of a via-to-via distance of a via array constituting an impedance matching network;

FIG. 5C is a comparative graph illustrating simulation results of impedance matching variation depending on variation of a position variable of a via array constituting an impedance matching network;

FIG. 5D is a comparative graph illustrating simulation results of impedance matching variation depending on variation of a via diameter variable of a via array constituting an impedance matching network;

FIG. 6 is a graph illustrating measured results of return loss of FIG. 1B;

FIG. 7 is a graph illustrating measured results of gain and axial ratio of FIG. 1B; and

FIG. 8 is a graph illustrating measured results of a radiation pattern of FIG. 1B.

### DETAILED DESCRIPTION OF THE INVENTION

Hereinafter, a detailed description of a preferred embodiment of the present invention with reference to the accompanying drawings is as follows. In the following description, a detailed description of known functions and configurations incorporated herein will be omitted when it may make the subject matter of the present invention rather unclear.

In the drawings, it is noted that the same or similar elements are denoted by the same reference numerals even though they are depicted in different drawings. Now, the preferred embodiment of the present invention will be described with reference to the accompanying drawings.

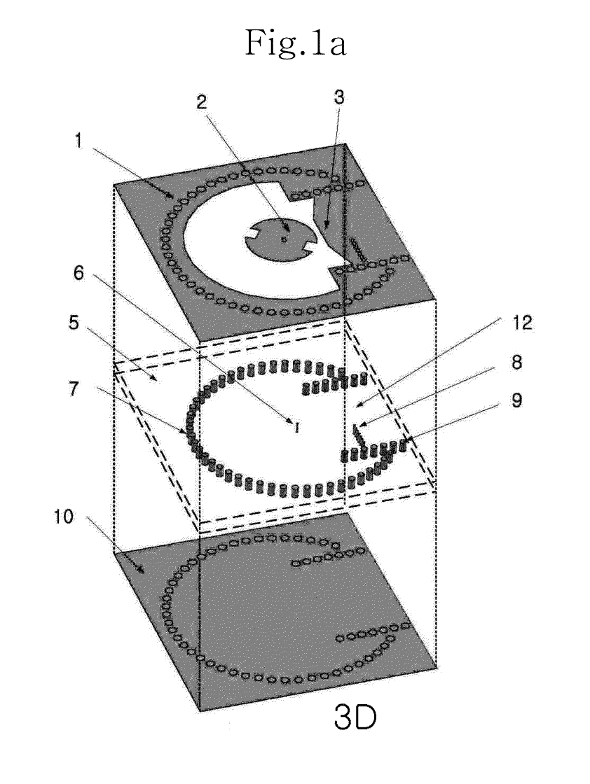

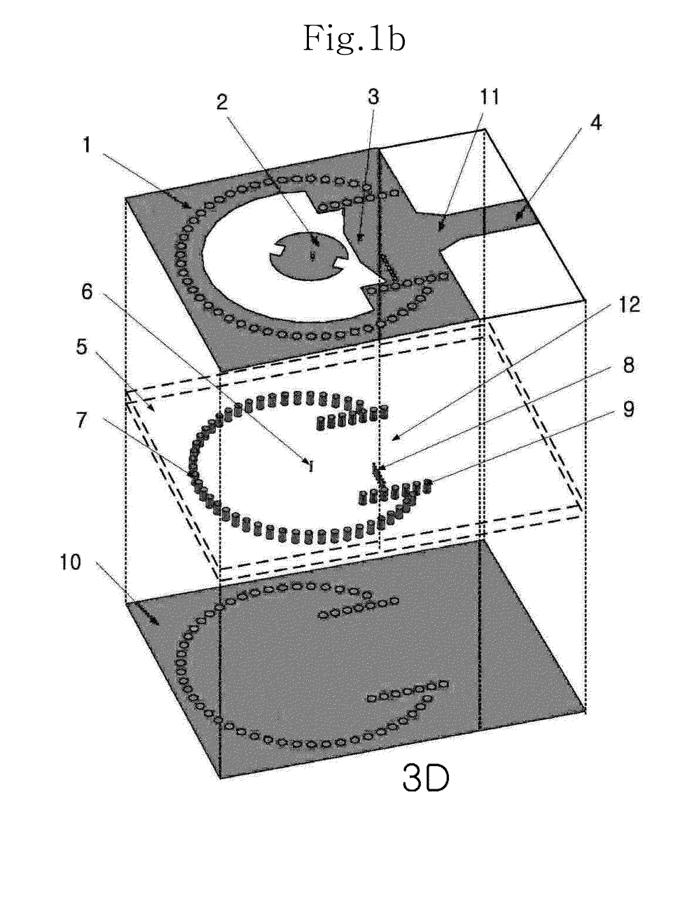

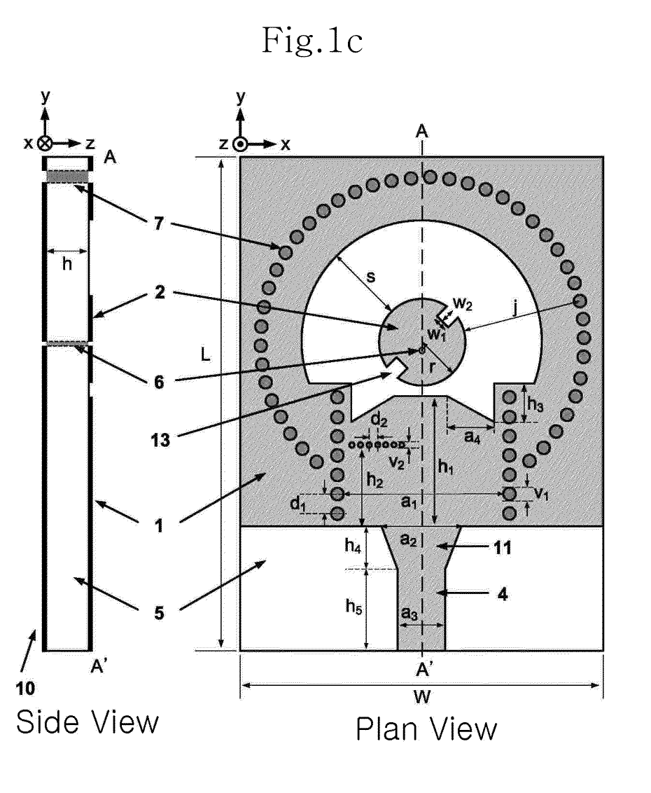

FIG. 1A is a 3D exploded perspective view of an antenna according to the present invention. In particular, the illustrated antenna is a circularly polarized antenna for satellite communication, which is of an X-band operating dielectric substrate integrated cylindrical cavity type.

As illustrated in FIG. 1A, the circularly polarized antenna for satellite communication, which is of a dielectric substrate integrated cylindrical cavity type, includes a dielectric substrate 5, an upper plate 1 provided over the dielectric substrate 5, and a lower plate 10 provided beneath the dielectric substrate 5.

The dielectric substrate 5 is provided with a first via array 7 defining a cylindrical cavity. A micro-strip circular patch antenna 2 is provided at the center of the cylindrical cavity for signal radiation. Here, the cylindrical cavity and the micro-strip circular patch antenna 2 serve as a radiator.

The dielectric substrate 5 is further provided with a rectangular dielectrically loaded waveguide 12 defined by a second via array 9. An upper plate etching pattern 3 and a third via array 8 are provided to constitute an impedance matching network to realize impedance matching between the rectangular dielectrically loaded waveguide 12 and the micro-strip circular patch antenna 2. Here, the rectangular dielectrically loaded waveguide 12, the upper plate etching pattern 3 and the third via array 8 serve as a feeder.

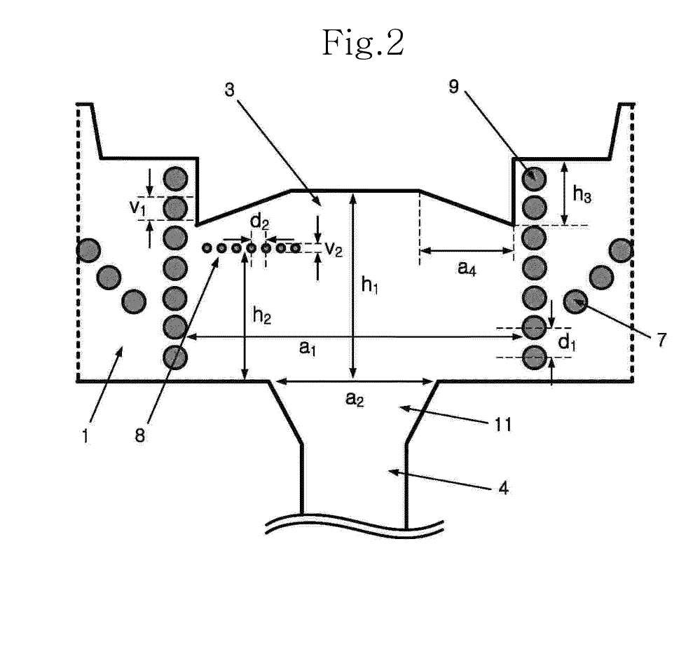

The second via array 9 and the third via array 8 are formed perpendicular to each other on the dielectric substrate 5. The third via array 8 is formed in a given direction, i.e. at the right or left side of the waveguide 12 with a dielectric insert. In the preferred embodiment of the present invention, the third via array 8 is described as being formed at the left side of the dielectrically loaded waveguide 12 as illustrated in FIG. 2 in plan view.

FIG. 1B illustrates a coupling relationship between a micro-strip line 4 and a signal transition 11 used for signal feed between the micro-strip line 4 and the dielectrically loaded waveguide 12, to measure characteristics of the antenna of FIG. 1A.

FIG. 1C is a side view and a plan view of FIG. 1B. As illustrated in FIG. 1C, the dielectric substrate 5 has a predetermined thickness h. The upper plate 1 and the lower plate 10, which are flat metal plates, are attached to the dielectric substrate 5, constituting a single substrate.

The micro-strip circular patch antenna 2 is formed with two slots 13. The micro-strip circular patch antenna 2 is designed to generate a Right Hand Circularly Polarized (RHCP) wave by use of the two slots 13. A probe via 6 having a diameter of 0.3 mm is used for electrical short circuit between the micro-strip circular patch antenna 2 and the lower plate 10. A position of the probe via 6 has an effect on impedance matching, and a rotation degree of the probe via 6 about the center of the micro-strip circular patch antenna 2 may determine a purity and a center frequency of an axial ratio.

In the present invention, the slots 13 are formed at arbitrary positions to create two electric fields, which have the same magnitude and a phase difference of 90 degrees. The axial ratio of the antenna is determined by the two slots 13. Specifically, the purity and the center frequency of the axial ratio may be adjusted according to an area of the slot 13 and a ratio of a horizontal length W1 to a vertical length W2 of the area.

The first via array 7 defining the cylindrical cavity and the second via array 9 defining the rectangular dielectrically loaded waveguide 12 electrically connect the upper plate 1 and the lower plate 10 to each other and thus, are short circuited with each other. These first and second via arrays 7 and 9 are designed such that internally proceeding waves recognize them as metal walls. The first and second via arrays 7 and 9 have the same via diameter v₁ of 1 mm and the same via-to-via distance d₁ of 1.5 mm. Accordingly, the first and second via arrays 7 and 9 may act as flat metal walls at a frequency of 10 GHz having a constant wavelength of approximately 30 mm.

FIG. 2 is a detailed plan view illustrating an impedance matching network of FIG. 1C in enlarged scale. The impedance matching network is integrated inside the rectangular dielectrically loaded waveguide 12. The feeder defined by the rectangular dielectrically loaded waveguide 12 is designed such that a horizontal length a₁ thereof has a value of 16 mm according to a standard waveguide design criterion, to enable operation at an X-band center frequency of 10 GHz. In this case, a recommended frequency band is 8.2˜12.4 GHz. Since a cut-off frequency for TE10 mode as a fundamental mode of the feeder is 6.3 GHz, wave propagation is impossible at a frequency band less than 6.3 GHz.

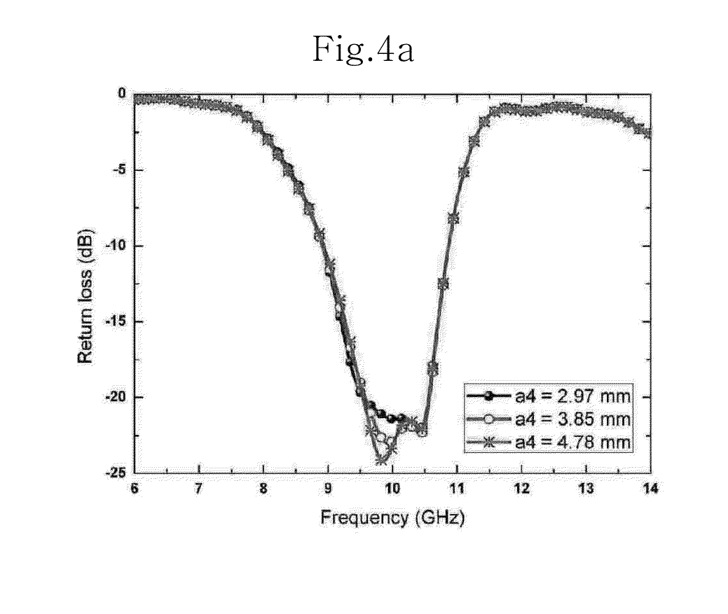

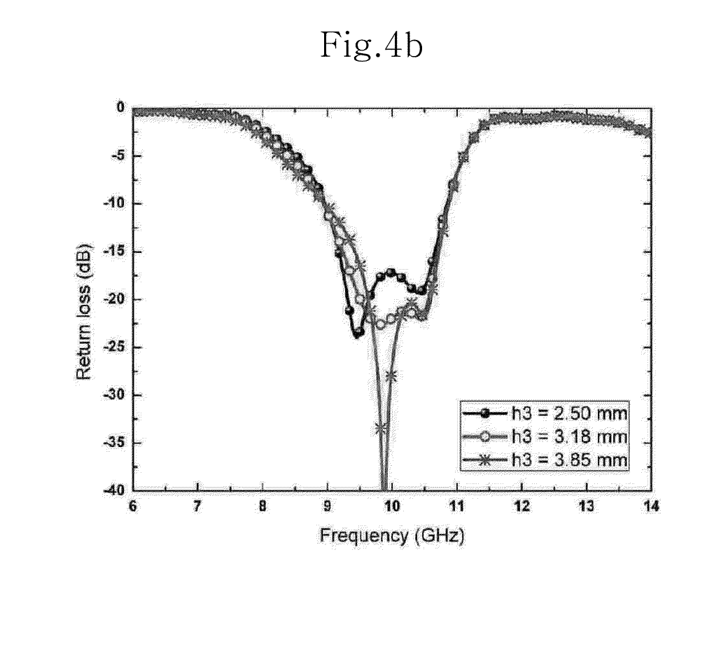

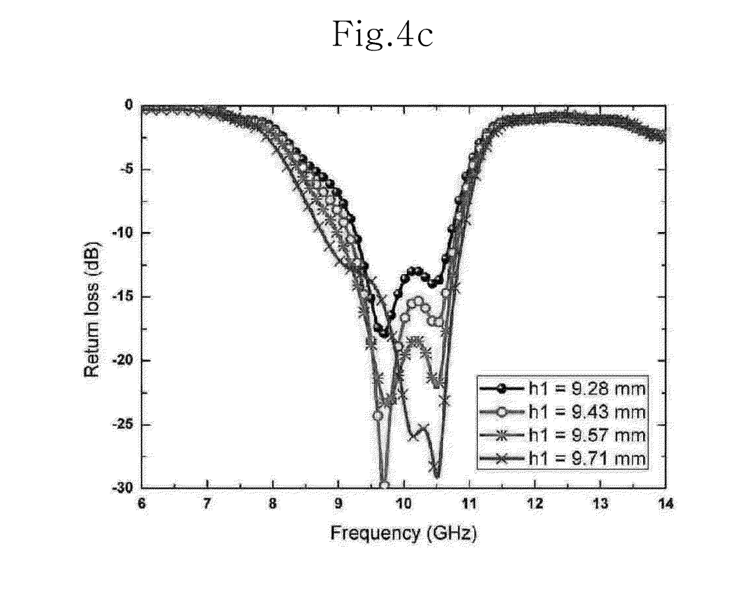

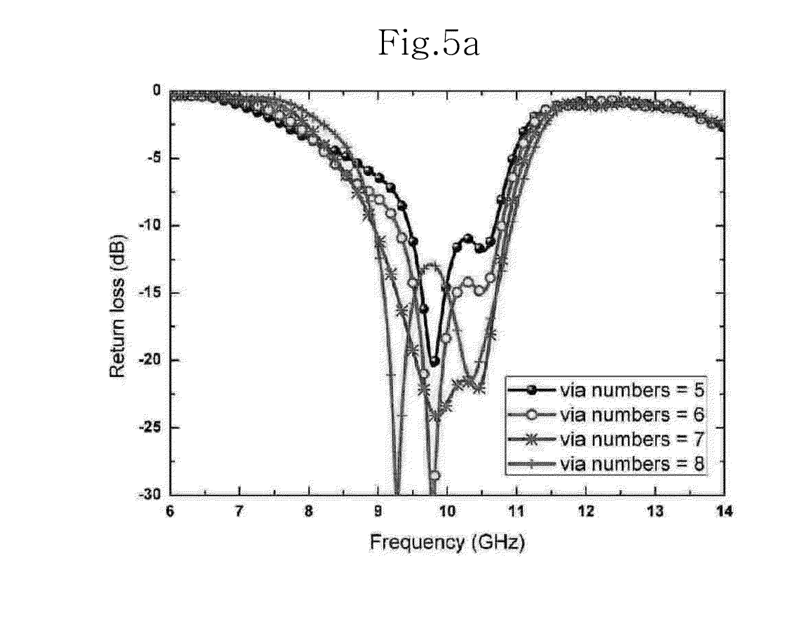

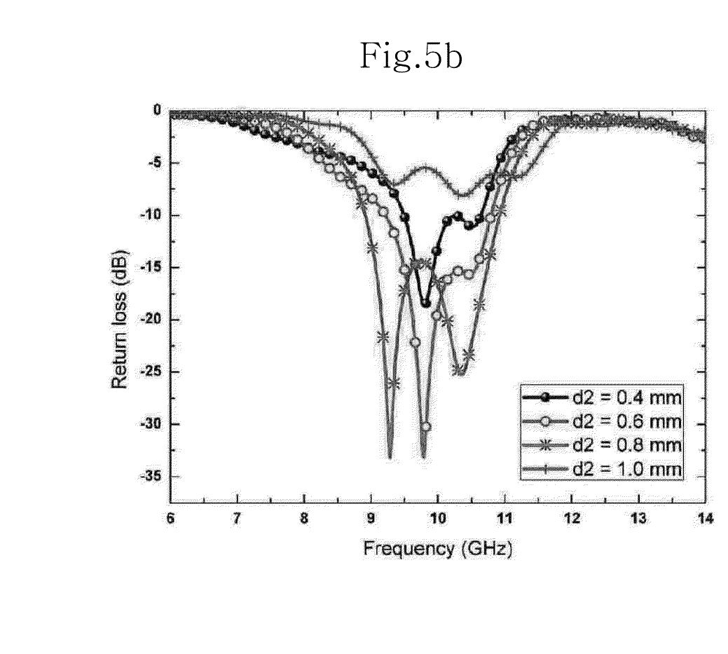

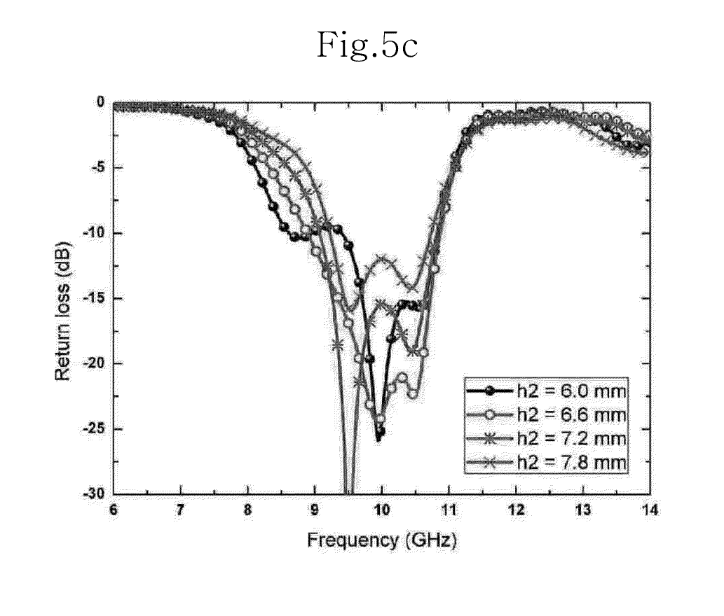

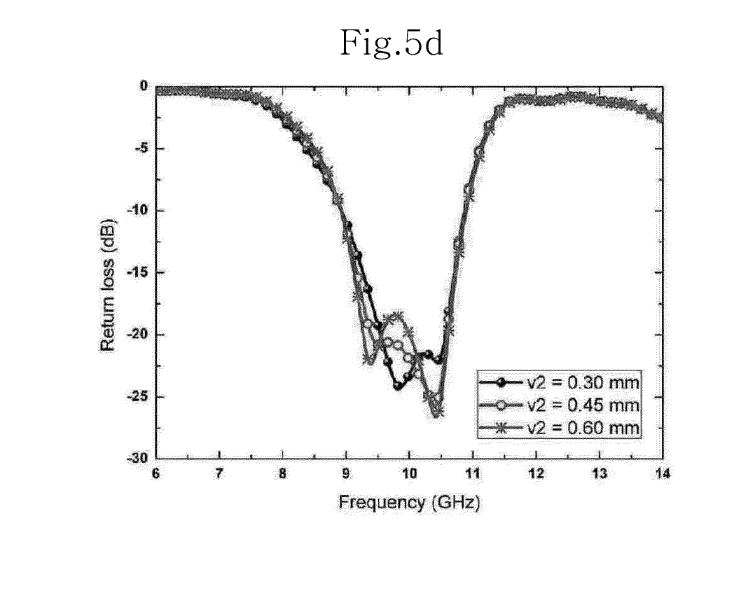

The impedance matching network of FIG. 2 consists of the third via array 8 and the etching pattern 3 of the upper plate 1. The etching pattern 3 is determined by a combination of variables h₁, h₃ and a₄, and the third via array 8 is determined by a via count and a combination of variables d₂, h₂ and v₂. Detailed roles of the respective variables will be described hereinafter in detail with reference to FIGS. 4A to 4C and FIGS. 5A to 5D.

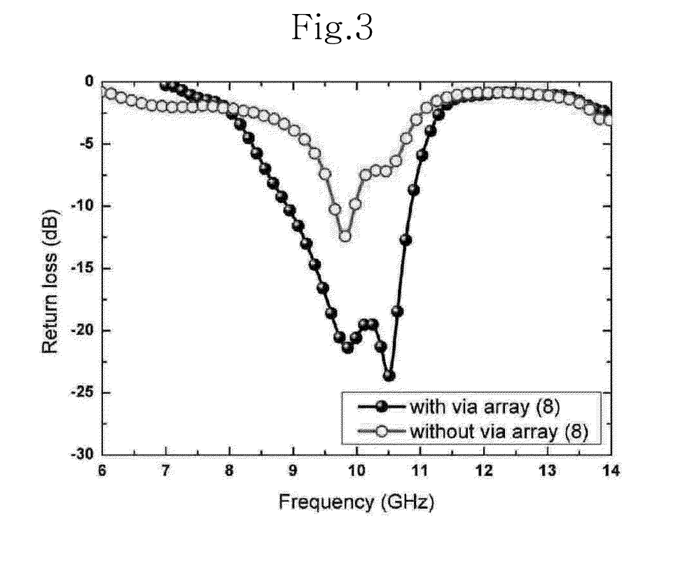

FIG. 3 illustrates comparative simulation results of impedance bandwidth variation depending on the presence or absence of the third via array 8 of the impedance matching network. In particular, FIG. 3 clearly illustrates an impedance matching degree depending on the presence or absence of the third via array 8 on the basis of return loss of −10 dB and −14 dB.

FIG. 4A is a graph illustrating simulation results of variation of a horizontal value a₄ of the etching pattern 3 constituting the impedance matching network. The variation of the horizontal value a₄ of the etching pattern 3 mainly has an effect on impedance matching with respect to resonance generated at a frequency of 9.7 GHz, and substantially has no effect on variation of a −10 dB impedance bandwidth and −14 dB impedance bandwidth. That is, when an optimum pattern horizontal value of the etching pattern is obtained within a corresponding frequency band, the horizontal value may be used as a valuable variable for realization of stabilized return loss.

FIG. 4B is a graph illustrating simulation results of variation of a vertical value h₃ of the etching pattern 3 constituting the impedance matching network. It can be confirmed from FIG. 4B that the −14 dB impedance bandwidth undergoes remarkable variation according to the vertical component h₃.

FIG. 4C is a graph illustrating simulation results of variation of an entire length value h₁ of the etching pattern 3 constituting the impedance matching network. The feeder defined by the dielectrically loaded waveguide 12 is necessary to transmit a wave close to the micro-strip circular patch antenna 2 to the maximum extent, in order to transmit maximum energy to the micro-strip circular patch antenna 2 with minimum return loss. However, if the entire length of the etching pattern 3 is excessively long and thus, nears the micro-strip circular patch antenna 2, this may exacerbate a metal-to-metal coupling phenomenon, causing impedance variation of the micro-strip circular patch antenna 2. As can be confirmed from the graph of FIG. 4C, although impedance matching is more stabilized as the entire length value h₁ of the etching pattern 3 increases up to 9.57 mm thus resulting in a wide impedance bandwidth on the basis of the return loss of −14 dB, the impedance bandwidth may be reduced if the entire length value h₁ of the etching pattern 3 exceeds 9.57 mm and thus, excessively nears the micro-strip circular patch antenna 2. Accordingly, it is preferable to appropriately set the length of the etching pattern 3 via experimentation.

In addition to constituting the impedance matching network, the third via array 8 further serves as a transformer for a mode transformation from TE10 mode as a fundamental mode of the feeder defined by the rectangular dielectrically loaded waveguide 12 to TM11 mode as a fundamental mode of the micro-strip circular patch antenna 2.

As illustrated in FIG. 2, the third via array 8 is determined by a via count and a combination of position variables h₂ and d₂ and a via diameter variable v₂.

FIG. 5A is a graph illustrating simulation results of variation of a via count of the third via array 8 constituting the impedance matching network. Under the condition in that the via diameter v₂ has a value of 0.3 mm and the distance d₂ between the vias has a value of 0.7 mm, the via count is selected in a range of 5˜8. As can be confirmed from FIG. 5A, the stabilized return loss of −14 dB or less is obtained as the via count increases from 5 to 7. In addition, it can be confirmed that, if the via count increases to 8, a distance between two resonance frequencies begins to increase and it is impossible to satisfy the return loss criterion of −14 dB in which a Voltage Standing Wave Ratio (VSWR) is 1.5:1.

FIG. 5B is a graph illustrating return loss simulation results depending on variation of the via-to-via distance d₂ of the third via array 8 constituting the impedance matching network. Variation of the via-to-via distance causes variation of a capacitive via coupling degree, thus having an effect on impedance variation. Furthermore, if the via-to-via distance increases beyond a predetermined level, an allowable wave passage width is reduced thus causing return of a great quantity of electricity and resulting in increased return loss. Confirming this principle from the graph of FIG. 5B, although impedance matching is improved as the via-to-via distance d₂ increases from 0.4 mm to 0.6 mm, a distance between two resonance frequencies increases if the via-to-via distance d₂ is 0.8 mm and thus, it is impossible to satisfy a −14 dB impedance bandwidth. In addition, if the via-to-via distance d₂ is equal to 1 mm, the third via array 8 of the impedance matching network acts as a metal wall thus returning a great quantity of electricity and resulting in increased return loss. That is, it is preferable to satisfy an optimum impedance matching condition by appropriately varying the via-to-via distance d₂.

FIG. 5C is a graph illustrating return loss simulation results depending on variation of the position variable h₂ of the third via array 8 constituting the impedance matching network. The position variable h₂ is determined based on the signal transition 11 and falls within a range of 0˜7.8 mm. As can be confirmed from the graph of FIG. 5C, the maximum impedance matching is obtained when the position variable h₂ is in a range of 6.6˜7.2 mm, and it is impossible to satisfy an impedance bandwidth in a position range outside the above mentioned range.

FIG. 5D is a graph illustrating return loss simulation results depending on variation of the via diameter variable v₂ of the third via array 8 constituting the impedance matching network. This simulation compares characteristic results in consideration of a via diameter that can be actually realized. As can be confirmed from the simulation results, if a via diameter is selected in a range of 0.3˜0.6 mm, it is possible to satisfy an approximately −14 dB impedance bandwidth although slight resonance frequency variation occurs. Therefore, the via diameter may be changed in consideration of manufacturing environments.

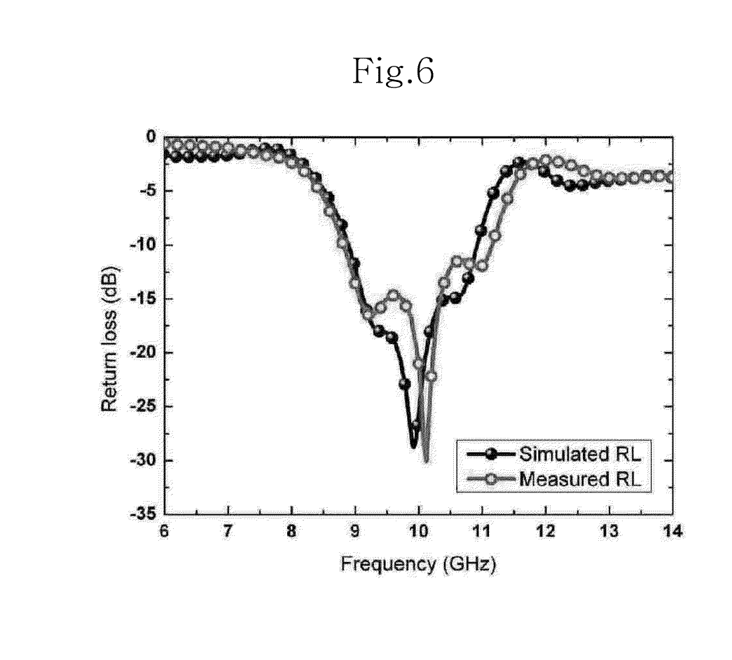

FIG. 6 is a graph illustrating simulation results and measured results of return loss of the finally designed antenna obtained via optimization of antenna variables. In this case, the simulation results and the measured results approximately coincide with each other. The measured return loss shows a wide impedance bandwidth of 2.34 GHz (23.42%) corresponding to a frequency range of 8.82˜11.16 GHz on the basis of the return loss of −10 dB in which the voltage standing wave ratio is 2:1. The return loss simulation results show an impedance bandwidth of 1.4 GHz (14.43%) corresponding to a frequency range of 9˜10.4 GHz on the basis of the return loss of −14 dB in which the voltage standing wave ratio is 1.5:1 according to a standard satellite communication antenna criterion.

The circularly polarized antenna for satellite communication, which is of a dielectric substrate integrated cylindrical cavity type according to the present invention, is able to overcome a disadvantage of a conventional micro-strip patch antenna including a narrow impedance bandwidth. This is accomplished by optimum mode transformation using an impedance matching network integrated in the feeder defined by the dielectrically loaded waveguide 12.

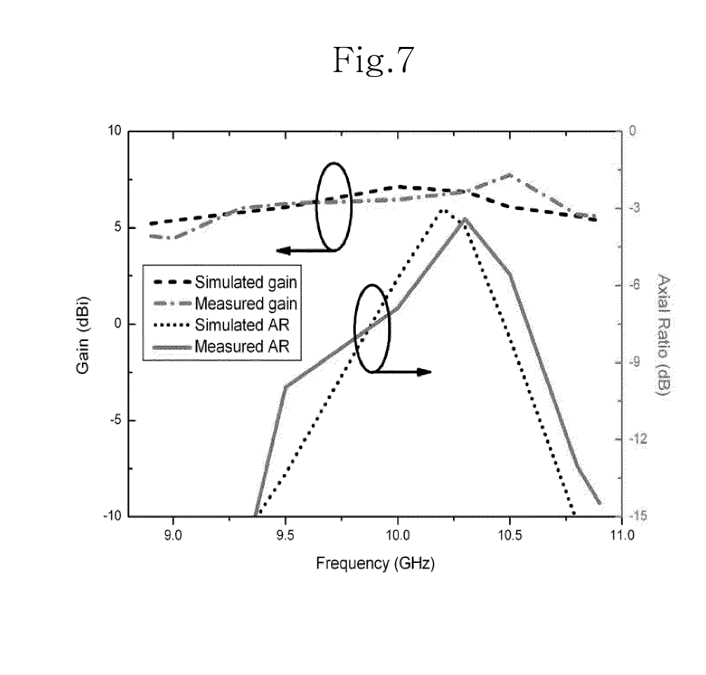

FIG. 7 is a comparative graph illustrating simulation results and measured results of gain and axial ratio according to the present invention. It can be confirmed that the simulation results and the measured results of the gain and axial ratio coincide with each other, and that stabilized antenna characteristics can be realized via optimization of antenna variables.

The gain of the present invention varies from 4.8 dBi to 7.5 dBi in a frequency range of 8.9˜10.9 GHz, and exhibits uniform variation in a range of 3 dBi or less thus assuring stabilized antenna characteristics.

The axial ratio of a right hand circularly polarized wave according to the present invention shows maximum purity at a frequency of 10.3 GHz and may accomplish the same characteristics as the simulation results.

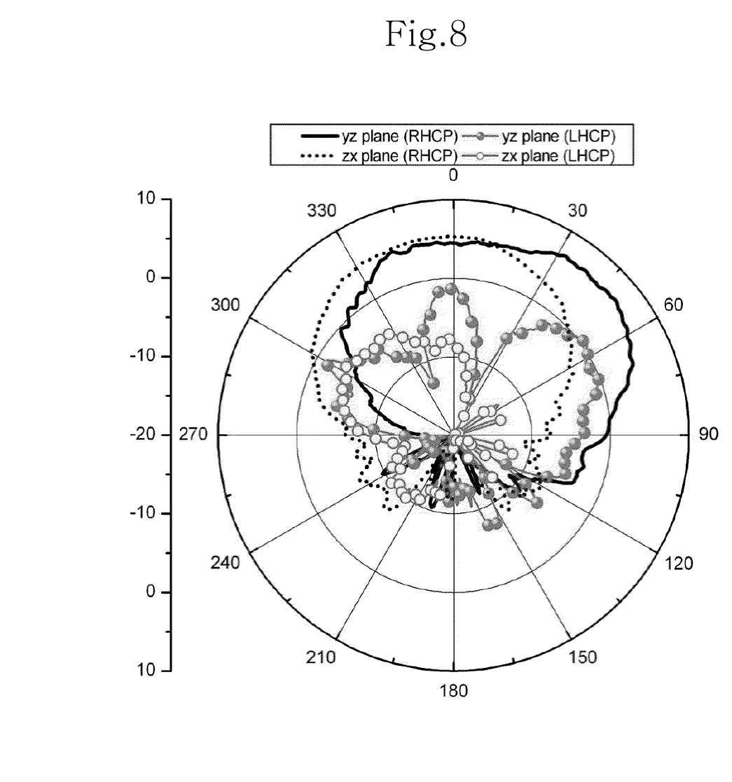

FIG. 8 is a graph illustrating measured results of a radiation pattern according to the present invention. Referring to the coordinate system of FIG. 1C, the antenna of the present invention generates a right hand circularly polarized (RHCP) wave and a left hand circularly polarized (LHCP) wave with respect to yz and zx planes. The measured frequency is 10.3 GHz, and it can be confirmed that the right hand circularly polarized wave prevails in all planes. In particular, as a result of confirming a ratio of the right hand circularly polarized wave to the left hand circularly polarized wave of a z-axis (Θ=0°) with respect to a zx plane (Φ=0°, 0°≦Θ≦360°), a high purity circularly polarized wave can be realized on the basis of return loss of 15 dB.

As apparent from the above description, advantageous effects of the present invention are as follows.

Firstly, according to the present invention, a single device antenna for use in a satellite array antenna for data communication can be designed based on stabilized gain and circular polarization.

Secondly, according to the present invention, a small circularly polarized antenna can be integrated on a single substrate. This realizes a light-weight planar antenna having a simplified configuration as compared to conventional antennas having several structural drawbacks. Accordingly, it is possible to realize a circularly polarized antenna for satellite communication, which has high resistance against external vibration and is suitable for space environments.

Thirdly, according to the present invention, a narrow bandwidth due to a small thickness of a dielectric substrate can be eliminated with use of an impedance matching network integrated in the antenna, providing the antenna with a wide impedance bandwidth.

Fourthly, according to the present invention, it is possible to attain a stabilized right hand circularly polarized wave from a micro-strip circular patch antenna having a slot or perturbation. Furthermore, the antenna can be easily converted to generate a left hand circularly polarized wave by varying a position of the slot or a position of a via array of the impedance matching network (from the left side to the right side).

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A circularly polarized antenna for satellite communication comprising:
a dielectric substrate having a first via array in the form of a cylindrical cavity;
a micro-strip circular patch antenna located at the center of the cylindrical cavity and formed on the dielectric substrate to radiate a signal; and
a rectangular dielectrically loaded waveguide having a second via array and serving to feed the signal to the micro-strip circular patch antenna.

2. The antenna according to claim 1, further comprising:
a lower plate provided beneath the dielectric substrate and made of a flat metal plate; and
an upper plate provided over the dielectric substrate and made of a flat metal plate.

3. The antenna according to claim 1, wherein the rectangular dielectrically loaded waveguide is formed in the dielectric substrate.

4. The antenna according to claim 3, further comprising an etching pattern and a third via array constituting an impedance matching network to realize impedance matching between the rectangular dielectrically loaded waveguide and the micro-strip circular patch antenna.

5. The antenna according to claim 1, further comprising a micro-strip line formed on an upper plate located over the dielectric substrate and serving to receive the signal.

6. The antenna according to claim 5, wherein the second via array is parallel to the micro-strip line and is formed at left and right sides of the micro-strip line.

7. The antenna according to claim 4, wherein the third via array is perpendicular to the second via array and is formed at a left or right side of the micro-strip line.

8. The antenna according to claim 7, wherein the third via array serves not only as the impedance matching network, but also as a transformer for mode transformation from TE10 mode as a fundamental mode of a feeder defined by the rectangular dielectrically loaded waveguide to TM11 mode as a fundamental mode of the micro-strip circular patch antenna.

9. The antenna according to claim 2, wherein the upper plate includes a signal transition connected to one end of the micro-strip line for transmission of the signal between the micro-strip line and the dielectrically loaded waveguide.

10. The antenna according to claim 4, wherein the micro-strip circular patch antenna has a slot to create two electric fields, which have the same magnitude and a phase difference of 90 degrees.

11. The antenna according to claim 10, wherein the micro-strip circular patch antenna adjusts a purity and center frequency of an axial ratio according to an area of the slot and a ratio of a horizontal length value to a vertical length value of the area.

12. The antenna according to claim 11, wherein the micro-strip circular patch antenna includes a probe via to be electrically short circuited with the lower plate.
